(19) United States
(12) Patent Application Publication
(10) Pub. No.: US 2014/0071153 A1
(43) Pub. Date: Mar. 13, 2014

(54) IMAGE PROCESSING METHOD AND IMAGE DISPLAY DEVICE

(71) Applicant: Chang-Jing Yang, Taoyuan Hsien (TW)

(72) Inventor: Chang-Jing Yang, Taoyuan Hsien (TW)

(21) Appl. No.: 13/614,830

(22) Filed: Sep. 13, 2012

(51) Int. Cl. G09G 5/02

(52) U.S. Cl. 345/590

(57) ABSTRACT

An image display device is disclosed. The image display includes a quantizer, a halftone processing module, and a gamut mapping module. The quantizer is configured for executing a quantization process to an input image to generate a quantized image. The halftone processing module is configured for executing a halftone process for operating a quantization error between the input image and the quantized image to generate a dithering matrix. The gamut mapping module is configured for executing a gamut mapping process for operating the quantized image and the dithering matrix to generate an output image.

### BACKGROUND OF THE INVENTION

1. Field of the Invention

The invention relates to an image processing method and a related image display device, and more particularly, to an image processing method and a related image display device for converting a color image into a halftone and compressed image.

2. Description of the Related Art

In recent years, electronic readers have gradually replaced hard copies of books in the consumer market. Electrophoretic displays (EPDs) have become popular candidates used for the display of electronic readers because of several superior features. First, they are reflective displays, which are more comfortable to read on than transmissive displays. Second, they are bistable, in that an image can be maintained on the observing surface when power is not being supplied. Power is only consumed when an image is being refreshed.

The main kinds of EPDs are the wet-type EPD (realized using a microcapsule or microcup), and the dry-type quick-response liquid powder display (QR-LPD). However, according to many studies and prior arts, an important result is that the contrast ratios of the optical reflectance of EPDs are less than 10. Moreover, the color gamut of EPDs is much lower than that of standard RGB (sRGB) color space. This may lead to poor image reproduction.

Therefore, in order to further mitigate the problems of the prior art, an improved hybrid gamut mapping and dithering algorithm (HGMDA) comprising a post-dithering algorithm (PDA) and a gamut mapping algorithm (GMA) is proposed.

### BRIEF SUMMARY OF THE INVENTION

A detailed description is given in the following embodiments with reference to the accompanying drawings.

Image processing methods and image display devices are provided.

In one exemplary embodiment, the disclosure is directed to an image processing method for a display. The display comprises a quantizer, a halftone processing module, and a gamut mapping module. The image processing method comprises the steps of: executing, by the quantizer, a quantization process to an input image to generate a quantized image; executing, by the halftone processing module, a halftone process for operating a quantization error between the input image and the quantized image to generate a dithering matrix; and executing, by the gamut mapping module, a gamut mapping process for operating the quantized image and the dithering matrix to generate an output image.

In one exemplary embodiment, the disclosure is directed to an image processing method for a display. The display comprises a gamut compression module, a quantizer, a halftone processing module, and a gamut clipping module. The image processing method comprises the steps of receiving, by the gamut compression module, an input image and executing a gamut compression process for operating the input image to generate a compressed image; executing, by the quantizer, a quantization process for operating the compressed image to generate a quantized image; executing, by the halftone processing module, a halftone process for operating a quantization error between the compressed image and the quantized image to generate a dithering matrix; and executing, by the gamut clipping module, a gamut clipping process for operating the quantized image and the dithering matrix to generate an output image.

In one exemplary embodiment, the disclosure is directed to an image display device. The image display device comprises a quantizer, a halftone processing module, and a gamut mapping module. The quantizer is configured for executing a quantization process to an input image to generate a quantized image. The halftone processing module is configured for executing a halftone process for operating a quantization error between the input image and the quantized image to generate a dithering matrix. The gamut mapping module is configured for executing a gamut mapping process for operating the quantized image and the dithering matrix to generate an output image.

In one exemplary embodiment, the disclosure is directed to an image display device. The image display device comprises a gamut compression module, a quantizer, a halftone processing module, and a gamut mapping module. The gamut compression module is configured for receiving an input image and executing a gamut compression process for operating the input image to generate a compressed image. The quantizer is configured for executing a quantization process for operating the compressed image to generate a quantized image. The halftone processing module is configured for executing a halftone process for operating a quantization error between the compressed image and the quantized image to generate a dithering matrix. The gamut clipping module is configured for executing a gamut clipping process for operating the quantized image and the dithering matrix to generate an output image.

### BRIEF DESCRIPTION OF THE DRAWINGS

The present invention can be more fully understood by reading the subsequent detailed description and examples with references made to the accompanying drawings, wherein:

FIG. 1 is a block diagram illustrating an image display device 100 according to an embodiment of the invention;

FIG. 2 is a schematic diagram of quantized data and a quantized error according to an embodiment of the invention;

FIG. 3 is a flowchart for illustrating the post-dithering algorithm according to an embodiment of the invention;

FIG. 4 is a flowchart for illustrating the gamut mapping process for constructing an output image according to an embodiment of the invention;

FIG. 5 is a schematic diagram of RGB compression for mapping the sRGB color space to the cRGB color space according to an embodiment of the invention;

FIG. 6 is a block diagram illustrating an image display device according to an embodiment of the invention;

FIGS. 7(a)˜7(b) illustrate the original images according to an embodiment of the invention;

FIGS. 7(c)˜7(d) illustrate the images in the cRGB color space obtained by using the RGB compression process according to an embodiment of the invention;

FIGS. 7(e)˜7(f) illustrate the quantized images with 16 gray levels according to an embodiment of the invention;

FIG. 7(g)˜7(h) illustrate the images in the cRGB color space obtained by using the post-dithering algorithm according to an embodiment of the invention;

FIGS. 8(a)˜8(b) illustrate the images reproduced by using the gamut clipping process according to an embodiment of the invention; and

FIGS. 8(c)˜8(d) illustrate the images obtained by using the hybrid gamut mapping and dithering algorithm according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

I. System Architecture

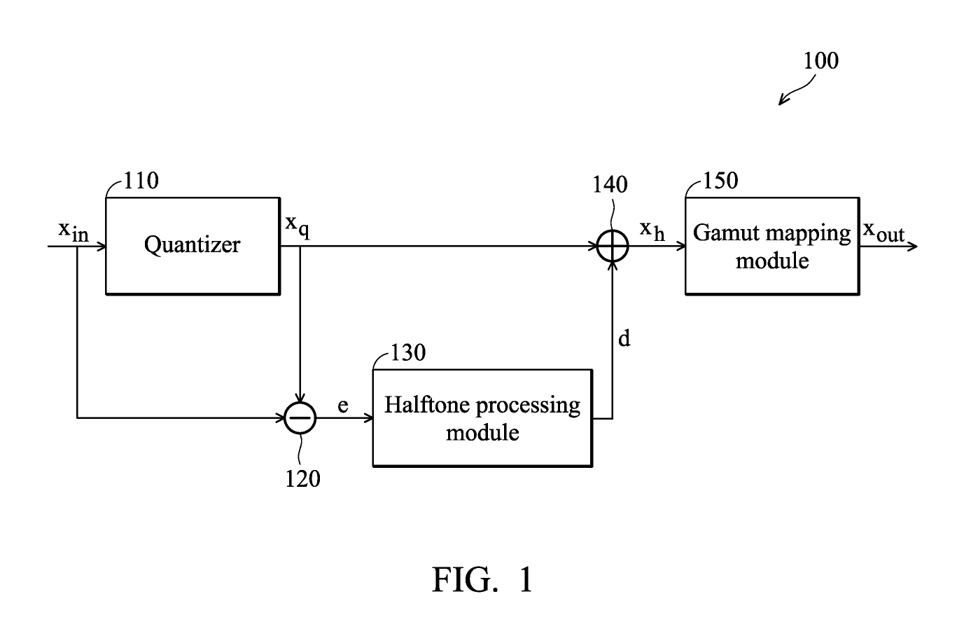

FIG. 1 shows a block diagram for illustrating an image display device 100 according to an embodiment of the invention. As shown in FIG. 1, the image display device 100 includes a quantizer 110, a subtractor 120, a halftone processing module 130, an adder 140, and a gamut mapping module 150.

The quantizer 110 has a first input terminal to receive RGB values of an input image xᵢₙ, in the sRGB color space and execute a quantization process for operating the input image xᵢₙ, to generate the RGB values of the quantized image x_{q} according to a predetermined threshold T.

The subtractor 120 is coupled to the quantizer 110 and has a first input terminal to receive the input image xᵢₙ. The subtractor 120 subtracts the RGB values of the quantized image x_{q} from the RGB values of the input image xᵢₙ so as to generate a quantization error e.

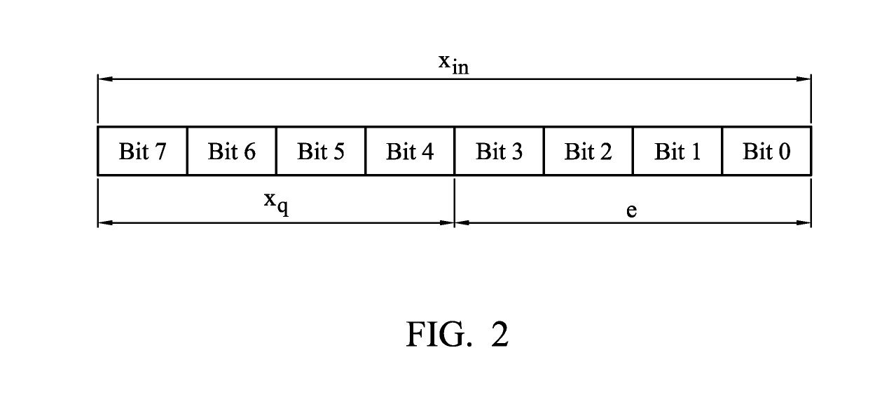

FIG. 2 is a schematic diagram of quantized data and a quantized error separation according to an embodiment of the invention. An image with 8-bit gray levels is used to be shown on an EPD with 4-bit gray level output. A uniform quantizer can be easily implemented by choosing the first 4 bits of the original 8-bit image data xᵢₙ. The remaining 4 bits denote the quantization errors e which are processed by the halftone processing module 130. The quantization errors e are post-dithered by the halftone processing module 130 after the quantization. For simplicity, a simple quantization sequence is achieved using the higher 4 bits as x_{q} and the lower 4 bits as the quantization error e. The examples are not to be limitative.

The halftone processing module 130 is coupled to the subtractor 120 and executes a halftone process to generate a dithering matrix d by using the quantization error e.

The adder 140 is coupled to the halftone processing module 130 and the quantizer 110. The adder 140 adds the RGB values of the quantized image x_{q} to the dithering matrix d and generates the dithered image xₕ.

The gamut mapping module 150 is coupled to the adder 140 and executes a gamut mapping process for operating the quantized image x_{q} and the dithering matrix d to generate an output image xₒᵤₜ.

In this embodiment, the proposed halftone process comprising a post-dithering algorithm (PDA) focuses on minimizing the visual errors of an image after quantization. Mathematically, the problem can be described as:

find the dithering matrix d which can minimize E{eᵥ²}, where the cost function of the minimum of the MSE of the visual error eᵥ can be written as:

$$E \{ {e}_{v}^{2} \} = {( {\sum }_{i = 1}^{I} {\sum }_{j = 1}^{J} ( {x}_{q} ( i , j ) + d ( i , j ) - {x}_{in} ( i , j ) ) * v ( i , j ) )}^{2} . \qquad ( 1 )$$

In this embodiment, i, j represent the i-th row and j-th column of an image with a resolution of I×J, respectively. The visual error eᵥ is the convolution sum of the modulation transfer function (MTF) of the human eye v(i, j) and the quantization error between the input image xᵢₙ, and the dithered image xₕ. However, the computation for finding the optimal solution of the function (1) is too complicated. Therefore, a simple algorithm proposed in the invention uses quantization error e to find a suboptimal solution of the dithering matrix d.

The image errors at low frequencies can be perceived by the human eye since the MTF of the eye acts as a low-pass filter. For example, the pixels whose gray levels are gradually increasing or decreasing show severe false contouring. Therefore, an image is divided with a resolution of I×J into K segments which are considered as local areas whose resolution is M×N, where K=I×J/M×N. In order to reduce the quantization errors at low frequencies of an image, the cost function in the function (1) can be modified as:

find d_{local}^{k} which can minimize E{e_{local}^{k 2}},

$$E \{ {e}_{local}^{{k}^{2}} \} = {\sum }_{m = 1}^{M} {\sum }_{n = 1}^{N} {( {e}_{local}^{k} ( m , n ) + {d}_{local}^{k} ( m , n ) )}^{2} \\ subject to {d}_{local}^{k} ( m , n ) = \{ 0 , \pm T \} , \qquad ( 2 )$$

where e_{local}^{k} represents the quantization error of the k-th local area and m and n represent the m-th row and the n-th column of the k-th local area. Since the quantizer is a threshold function, the components of the dithering matrix d should be the predetermined threshold T which is the interval between adjacent gray levels.

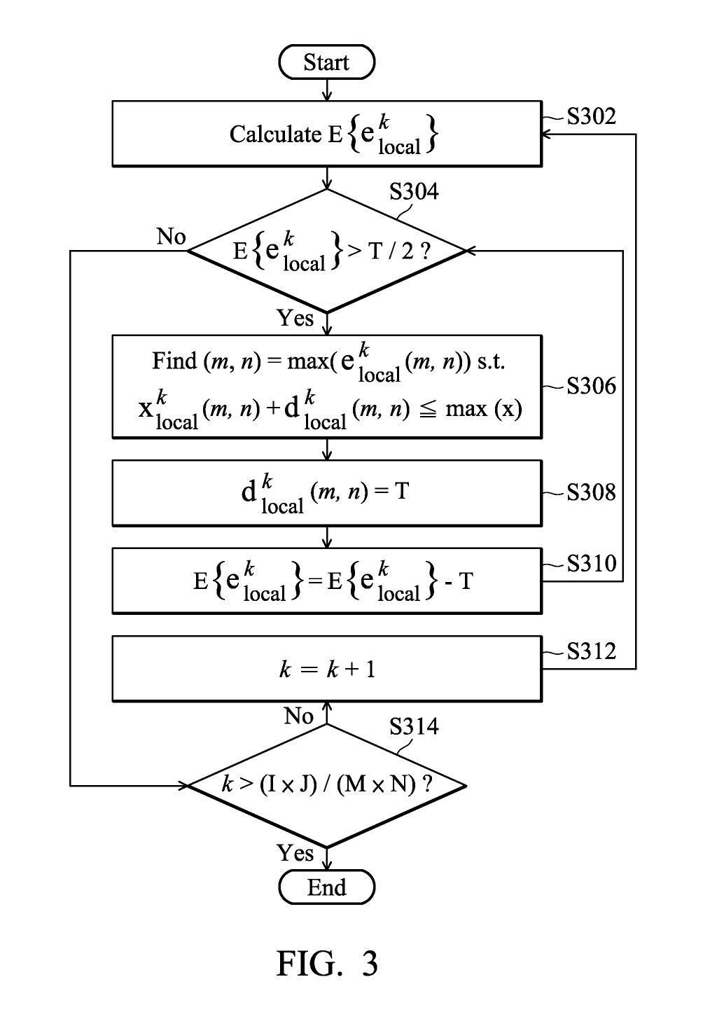

FIG. 3 is a flowchart for illustrating the post-dithering algorithm according to an embodiment of the invention. First, the size of the local area is determined and a counter k is initialized to a value of 1. In step S302, the total quantization error E{e_{local}^{k}} of the k-th local area is calculated. After that, in step S304, it is determined whether E{e_{local}^{k}} is greater than T/2. When E{e_{local}^{k}} is greater than T/2 (“Yes” in step S304), then step S306 is executed. In step S306, the pixel with the largest quantization error in the local area is considered as the first candidate to be dithered. Then, in step S308, the value of the pixel will be set to T in the dithering matrix d_{local}^{k}. It is worth noting that when the gray level of the pixel is equal to the maximum gray level, which cannot be dithered, the candidate will be altered to be the pixel with the second-largest quantization error. In step S310, E{e_{local}^{k}} is determined to equal E{e_{local}^{k}} minus T (E{e_{local}^{k}}=E{e_{local}^{k}}−T) and the flow goes back to step S304.

When E{e_{local}^{k}} is smaller than or equal to T/2 (“No” in step S304), in step S314, it is determined whether the counter k is greater than the number (I×J)/(M×N). When the counter k is smaller than or equal to the number (I×J)/(M×N) (“No” in step S314), in step S310, 1 is added to the counter k and the steps return to step S302 until the counter k is greater than the number (I×J)/(M×N) and the E{e_{local}^{k}} is minimized by adding d_{local}^{k} to x_{local}^{k}. Then, the operation is performed for the next local area. The dithering matrix d can be obtained by processing all local areas in the image. The dithered image xₕ is produced by adding the dithering matrix d to the quantized image x_{q}. Consequently, the quantization errors at low frequencies of the image are reduced by adding the dithering matrix d and the quantized image x_{q}.

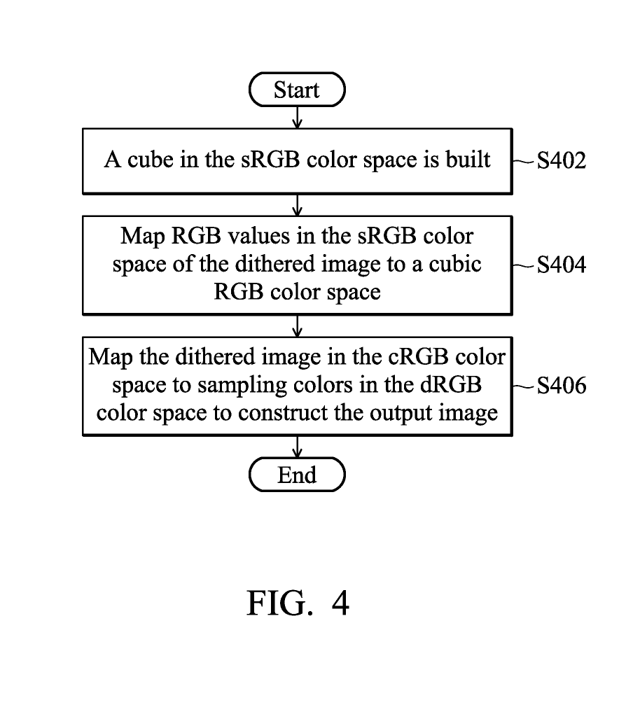

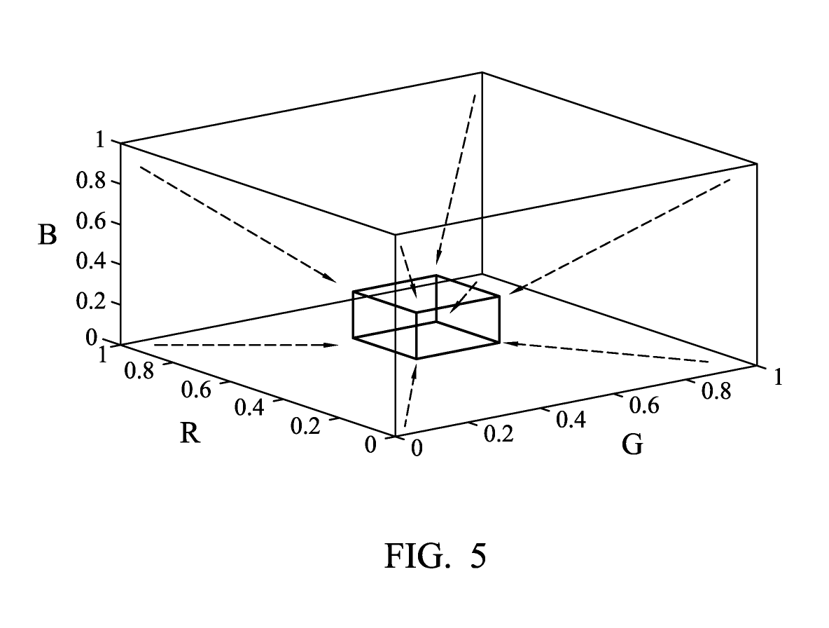

After the dithered image xₕ is generated by the adder 140, the gamut mapping module 150 executes the gamut mapping process to construct the output image xₒᵤₜ. FIG. 4 is a flowchart for illustrating the gamut mapping process for constructing an output image according to an embodiment of the invention. First, in step S402, a cube in the sRGB color space using the black and white points of the image display device is built. Then, in step S404, the gamut mapping module 150 maps RGB values in the sRGB color space of the dithered image xₕ to a cubic RGB (cRGB) color space. The compression processing in step S404 will now be described in greater detail. The examples are not to be limitative. Inside the cube, the RGB data are uniformly divided into 16 levels. The 4,096 colors are defined inside the cube referred to as the cubic RGB color space (cRGB). As shown in FIG. 5, the 4,096 colors in the sRGB color space can be compressed to those in the cRGB color space. The interval between the colors in the cRGB color space will be smaller than that in the sRGB color space. After compression, the colors in the cRGB color space are mostly inside the color gamut of an EPD. Next, in step S406, the gamut mapping module 150 maps the dithered image xₕ in the cRGB color space to sampling colors in the device RGB color space (dRGB) to construct the output image xₒᵤₜ. The processing of mapping the dithered image xₕ in the cRGB color space to sampling colors in the dRGB color space in step S406 will now be described in greater detail. The CIELAB color space is used to predict the lightness (L), chroma (C), and hue (H) of the colors. The minimum Euclidean distance is used to formulate the objective function of the mapping algorithm. The objective function can be described as:

Find x_{d}(γ) which minimize ΔE_{c},

$$Δ {E}_{c} = \sqrt{{( {x}_{c}^{L} ( τ ) - {x}_{d}^{L} ( γ ) )}^{2} + {( {x}_{c}^{C} ( τ ) - {x}_{d}^{C} ( γ ) )}^{2} + {( {x}_{c}^{H} ( τ ) - {x}_{d}^{H} ( γ ) )}^{2}} , \qquad ( 3 )$$

Where x_{c}^{L}(τ), x_{c}^{C}(τ) and x_{c}^{H}(τ) are the lightness, chroma, and hue, respectively, of the τth color x_{c}(τ) in the cRGB color space. x_{d}^{L}(γ), x_{d}^{C}(γ), and x_{d}^{H}(γ) are the lightness, chroma, and hue of the γth color x_{d}(γ) in the dRGB color space. Using (3), the colors in the cRGB color space can be mapped to the one with the closest color in the dRGB color space.

Moreover, a look-up table (LUT) is built to record the results of the gamut mapping process. By using the LUT, each color in the cRGB color space can find a corresponding color in dRGB color space.

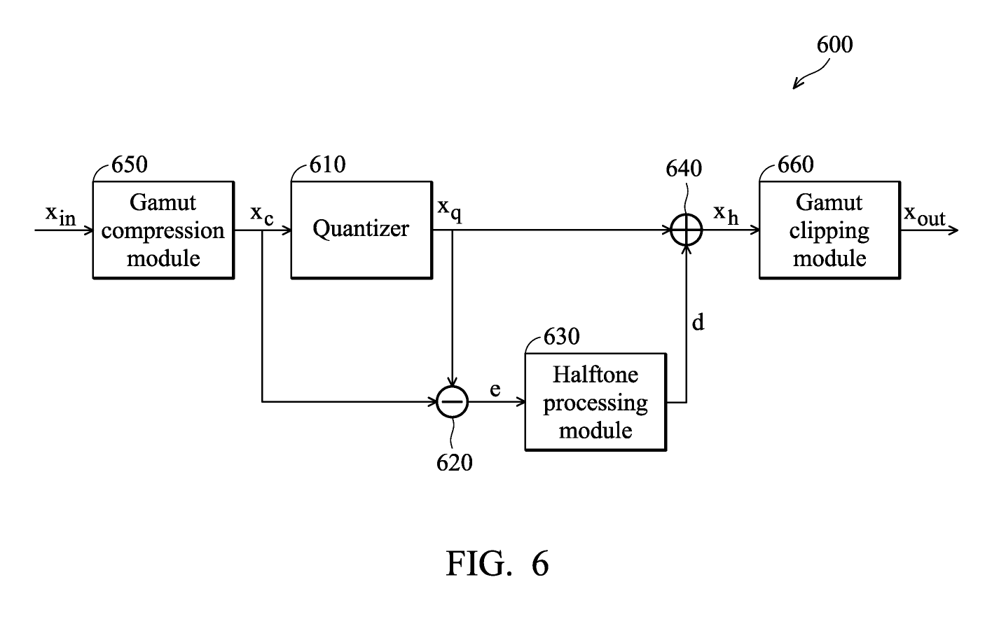

FIG. 6 is a block diagram illustrating an image display device 600 according to an embodiment of the invention. As shown in FIG. 6, the image display device 600 includes a quantizer 610, a subtractor 620, a halftone processing module 630, an adder 640, a gamut compression module 650, and a gamut clipping module 660. The subtractor 620 is coupled to the quantizer 610 and the gamut compression module 650. The halftone processing module 630 is coupled to the subtractor 620. The adder 640 is coupled to the halftone processing module 630, the quantizer 610 and the gamut clipping module 660. The components having the same name as described in the first embodiment have the same function. The main difference between FIG. 1 and FIG. 6 is that the gamut mapping module 150 is separated into two modules, which are the gamut compression module 650 and a gamut clipping module 660. In this embodiment, the gamut compression module 650 has a first input terminal to receive RGB values of an input image xᵢₙ in the sRGB color space and executes a gamut compression process for operating the input image xᵢₙ, to generate a compressed image x_{c}. Referring to FIG. 5, in this embodiment, after receiving the RGB values of the input image xᵢₙ, in the sRGB color space, the gamut compression module 550 executes the gamut compression process to map RGB values in the sRGB color space of the input image xᵢₙ to a cubic RGB (cRGB) color space. Then, the quantizer 610 executes a quantization process for operating the compressed image x_{c} to generate a quantized image x_{q}. The halftone processing module 530 executes a halftone process for operating a quantization error e between the compressed image x_{c} and the quantized image x_{q} to generate a dithering matrix d. The quantization process and the halftone process are the same as the illustration of the embodiment described above, so the details related to the technologies of the processes will be omitted. The adder 540 adds the RGB values of the quantized image x_{q} to the dithering matrix d and generates the dithered image xₕ. Finally, the gamut clipping module 660 executes a gamut clipping process for operating the quantized image x_{q} and the dithering matrix d to generate an output image xₒᵤₜ. The gamut clipping process will now be described in greater detail. The gamut mapping module 650 maps the dithered image xₕ in the cRGB color space to sampling colors in the dRGB color space to construct the output image xₒᵤₜ. The processing of mapping the dithered image xₕ in the cRGB color space to sampling colors in the dRGB color space is described above, so the details related to the technologies of the processes will be omitted. Moreover, a look-up table (LUT) is built to record the results of the gamut clipping process. By using the LUT, each color in the cRGB color space can find a corresponding color in the dRGB color space.

II. Experimental Results

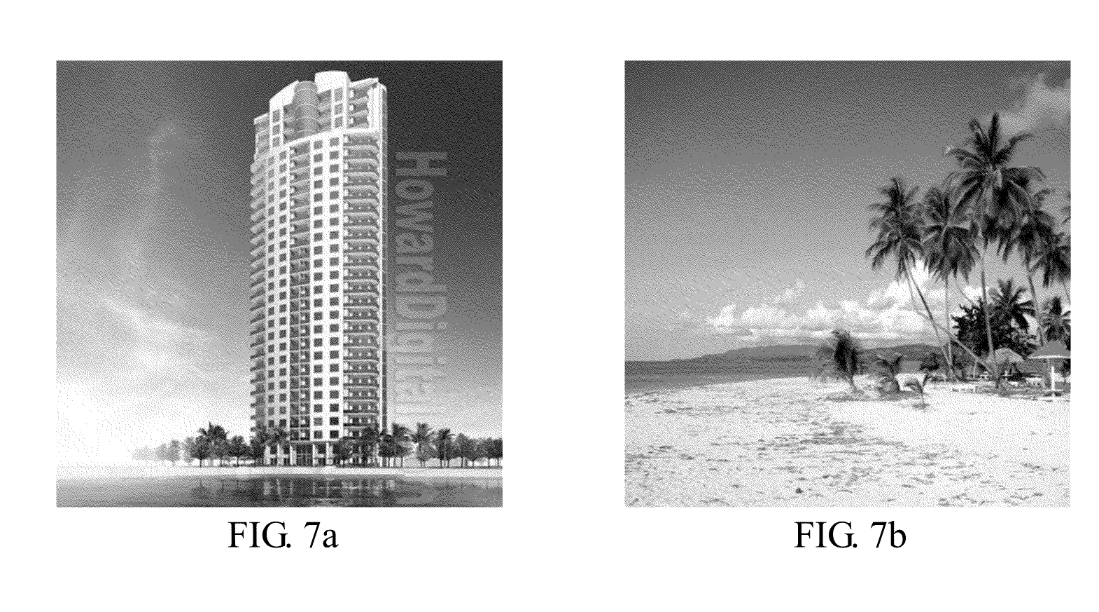

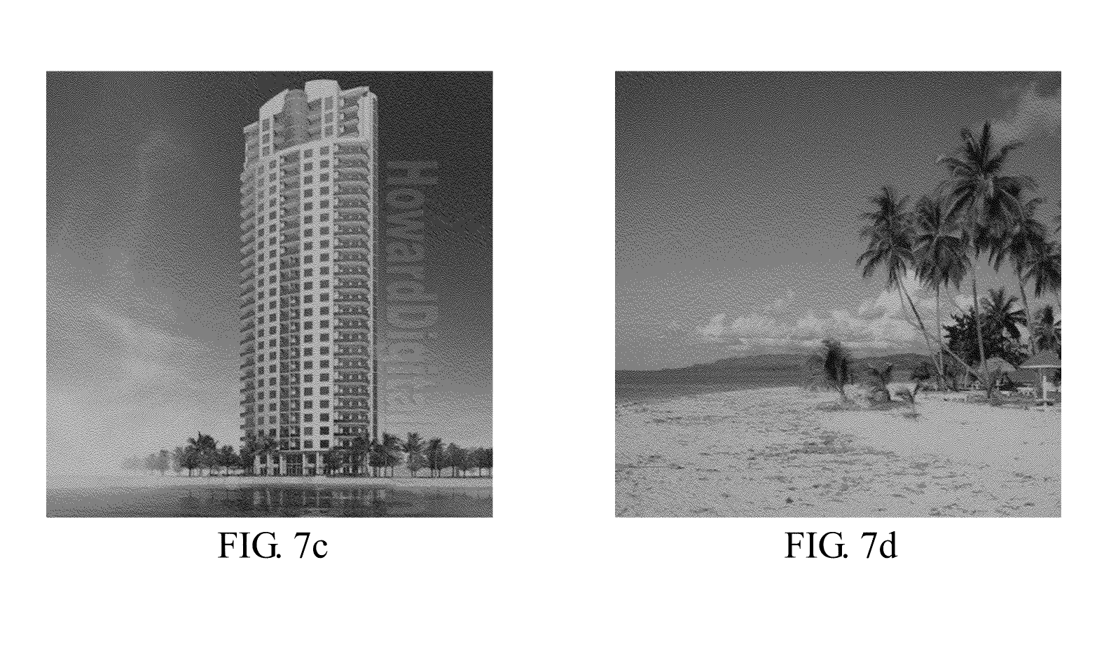

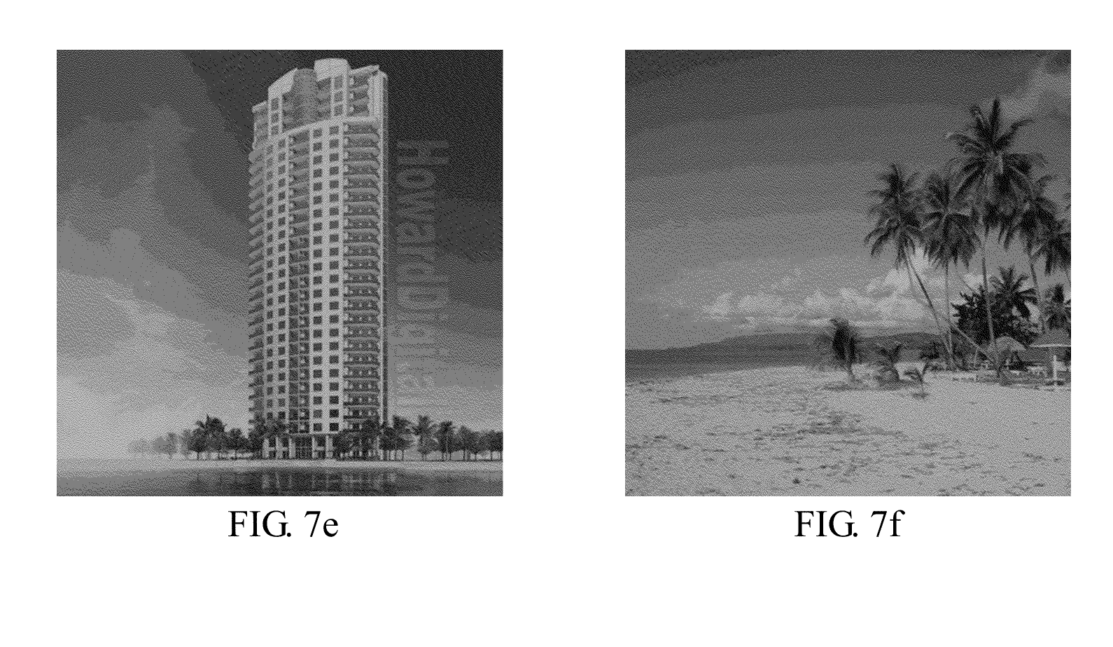

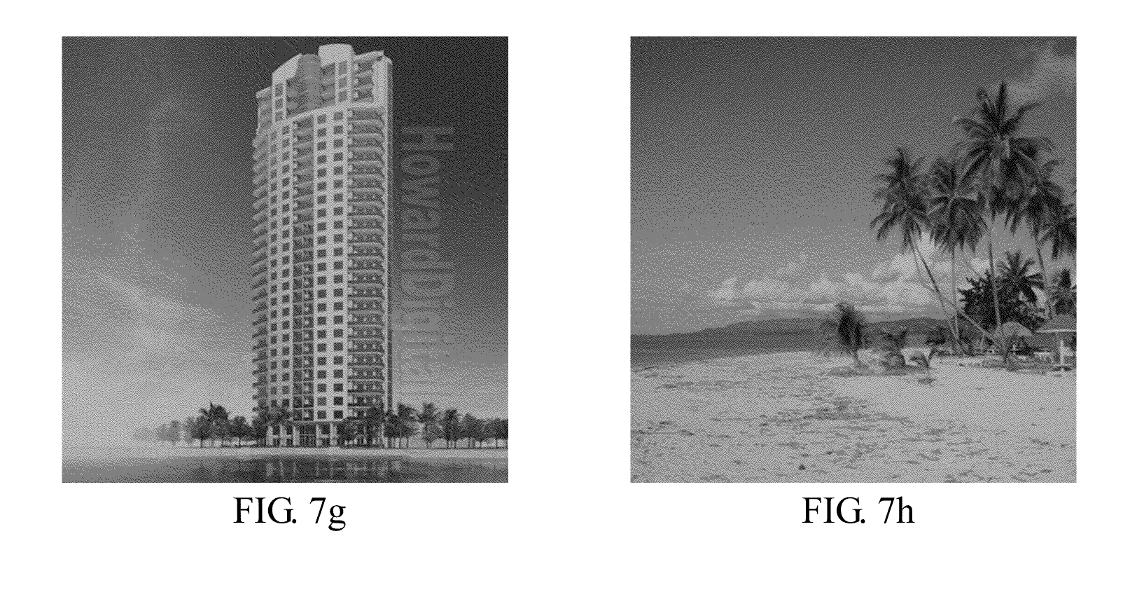

FIGS. 7(a) and 7(b) show the original 24-bit images, which are “Beach” and “Building”, respectively. The resolution of the original images is 500×500 pixels and 300 dpi. In this embodiment, the size of a local area is determined to be 4×4 pixels for the post-dithering algorithm (PDA). The sRGB color space defines colors within a unit cube that is produced by the black point (0, 0, 0) and white point (1, 1, 1). The contrast ratio of an electrophoretic display (EPD) is determined to be 10. The cRGB color space is produced by using the black point (0.07, 0.07, 0.07) and the white point (0.7, 0.7, 0.7). The RGB values of the original image in the sRGB color space are mapped to the cRGB color space by using the compression process as shown in FIGS. 7(c) and 7(d). The 12-bit quantized image of the image display device is shown in FIGS. 7(e) and 7(f), and the false contouring resulting from the quantization error occurs in both images. The quantized images are processed by using the post-dithering algorithm (PDA). The dithering images in the cRGB color space are shown in FIGS. 7(g) and 7(h). The false contouring is mitigated and the details in the images are preserved.

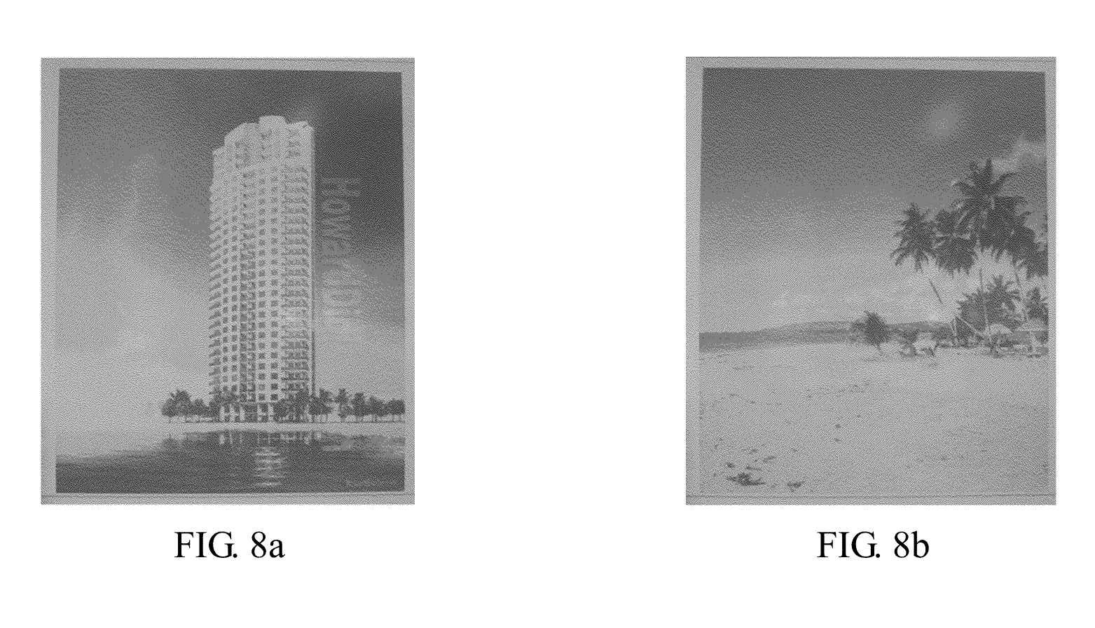

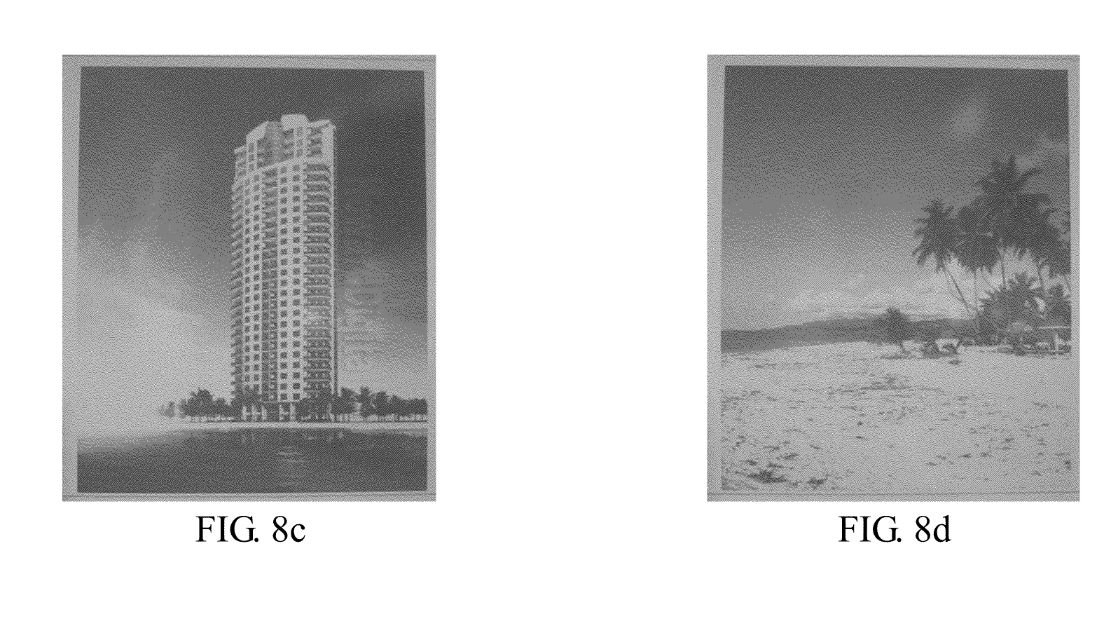

In this embodiment, the image display device is a quick-response liquid powder display (QR-LPD). Photographs of images reproduced on a QR-LPD are shown in FIGS. 8(a)˜8(d). The photographs of the images reproduced by using the gamut clipping process are shown in FIGS. 8(a) and 8(b), and the ones obtained by using the hybrid gamut mapping and dithering algorithm (HGMDA) are shown in FIGS. 8(c) and 8(d). However, although the lightness of images is increased by using the gamut clipping process, details of images are lost as well. On the contrary, most details in images are preserved while using HGMDA. Moreover, the contrast in the images is also increased.

III. Summary and Advantages

In this invention, a novel system of HGMDA consisting of the compression process, the quantization process, the post-dithering algorithm (PDA), and the gamut clipping process is proposed. As shown by the experimental results, false contouring is mitigated by using the post-dithering algorithm, and the color gamut mapping is achieved by using the RGB compression process and the gamut clipping process. When compared to the conventional method of using the gamut clipping algorithm, the details of images are preserved and the contrast is increased by using HGMDA. The high-efficiency image processing method is especially suitable for implementation in or association with a variety of electronic devices such as, but not limited to, mobile telephones, wireless devices, personal data assistants (PDAs), hand-held or portable computers, and electrophoretic displays.

It is understood that although each of the aforementioned modules or units of the invention has been illustrated as a single component of the device, two or more such components can be integrated together, thereby decreasing the number of the components within the device. Similarly, one or a multiple of the above components can be separately used, thereby increasing the number of the components within the device. In addition, the modules or the unit components of the invention can be implemented by any hardware, firmware, or software methods or combination thereof.

Systems and methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application-specific logic circuits.

While the invention has been described by way of example and in terms of preferred embodiment, it is to be understood that the invention is not limited thereto. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image processing method for a display, comprising the steps of:
executing, by a quantizer, a quantization process to an input image to generate a quantized image;
executing, by a halftone processing module, a halftone process for operating a quantization error between the input image and the quantized image to generate a dithering matrix; and
executing, by a gamut mapping module, a gamut mapping process for operating the quantized image and the dithering matrix to generate an output image.

2. The image generation method of claim 1, wherein the step of executing the quantization process comprises the steps of:
determining the size of a local area; and
calculating the quantization error of the local error.

3. The image generation method of claim 2, wherein the step of executing the halftone process comprises the steps of:
deciding to operate the local area while the quantization error of the local area is larger than half of a quantized gray level;
deciding to find the pixel having a maximum error to be dithered; and
stopping the halftone process while the quantization error of each local area is smaller than half of the quantized gray level.

4. The image generation method of claim 1, wherein the step of executing the gamut mapping process comprises the steps of:
mapping RGB values in the sRGB color space of a dithered image generated according to the input image and the quantized image to a cubic RGB (cRGB) color space;
mapping the RGB values of the halftone image in the cRGB color space to a device RGB (dRGB) color space of the display; and
building a look-up table to store the RGB values.

5. An image processing method for a display, comprising the steps of:
receiving, by a gamut compression module, an input image and executing a gamut compression process for operating the input image to generate a compressed image;
executing, by a quantizer, a quantization process for operating the compressed image to generate a quantized image;
executing, by a halftone processing module, a halftone process for operating a quantization error between the compressed image and the quantized image to generate a dithering matrix; and
executing, by a gamut clipping module, a gamut clipping process for operating the quantized image and the dithering matrix to generate an output image.

6. The image processing method of claim 5, wherein the step of executing a gamut compression process comprises the step of:
mapping RGB values in the sRGB color space of the input image to a cubic RGB (cRGB) color space.

7. The image processing method of claim 6, wherein the step of executing the quantization comprises the steps of:
determining the size of a local area; and
calculating the quantization error of the local error.

8. The image processing method of claim 7, wherein the step of executing the halftone process comprises the steps of:
deciding to operate the local area while the quantization error of the local area is larger than half of a quantized gray level;
deciding to find the pixel having a maximum error to be dithered; and
stopping the halftone process while the quantization error of each local area is smaller than half of a quantized gray level.

9. The image processing method of claim 6, wherein the step of executing a gamut clipping process comprises the steps of:
mapping the RGB values in the cRGB color space to the device RGB (dRGB) color space; and
building a look-up table to store the RGB values.

10. An image display device, comprising:
a quantizer, configured for executing a quantization process to an input image to generate a quantized image;
a halftone processing module, configured for executing a halftone process for operating a quantization error between the input image and the quantized image to generate a dithering matrix;
a gamut mapping module, configured for executing a gamut mapping process for operating the quantized image and the dithering matrix to generate an output image.

11. The image display device of claim 10, wherein the quantizer executes the quantization process to determine a size of a local area and calculate the quantization error of the local error.

12. The image display device of claim 11, wherein the halftone processing module executes the halftone process to decide to operate the local area while the quantization error of the local area is larger than half of a quantized gray level; decide to find the pixel having a maximum error to be dithered; and stop the halftone process while the quantization error of each local area is smaller than half of the quantized gray level.

13. The image display device of claim 11, wherein the gamut mapping module executes the gamut mapping process to map RGB values in a sRGB color space of a halftone image generated according to the input image and the quantized image to a cubic RGB (cRGB) color space; map the RGB values of the halftone image in the cRGB color space to a device RGB (dRGB) color space of the display; and build a look-up table to store the RGB values.

14. The image display device of claim 10, wherein the image display device is an electrophoretic display device.

15. An image display device, comprising:
a gamut compression module, configured for receiving an input image and executing a gamut compression process for operating the input image to generate a compressed image;
a quantizer, configured for executing a quantization process for operating the compressed image to generate a quantized image;
a halftone processing module, configured for executing a halftone process for operating a quantization error between the compressed image and the quantized image to generate a dithering matrix; and
a gamut clipping module, configured for executing a gamut clipping process for operating the quantized image and the dithering matrix to generate an output image.

16. The image display device of claim 15, wherein the gamut compression module executes the gamut compression process to map RGB values in a sRGB color space of the input image to a cubic RGB (cRGB) color space.

17. The image display device of claim 16, wherein the quantizer executes the quantization process to determine a size of a local area and calculate the quantization error of the local error.

18. The image display device of claim 17, wherein the halftone processing module executes the halftone process to decide to operate the local area while the quantization error of the local area is larger than half of a quantized gray level; decide to find the pixel having a maximum error to be dithered; and stop the halftone process while the quantization error of each local area is smaller than half of the quantized gray level.

19. The image display device of claim 16, wherein the gamut clipping module executes the gamut clipping process to map the RGB values of the halftone image in the cRGB color space to a device RGB (dRGB) color space of the display; and build a look-up table to store the RGB values.

20. The image display device of claim 19, wherein the image display device is an electrophoretic display device.
